(19) United States
(12) Patent Application Publication
(10) Pub. No.: US 2002/0082982 A1
(43) Pub. Date: Jun. 27, 2002

(54) Crop integrity auditing and reporting system and method

(76) Inventors: James J. Mock, Wichita, KS (US); Nancy J. Timmer, Seymour, IL (US); Russell L. Wilkin JR., Bluffton, IN (US)

Correspondence Address: Charles J. Meyer, Woodard, Emhardt, Naughton, Moriarty and McNett, Bank One Center/Tower, 111 Monument Circle, Suite 3700, Indianapolis, IN, 46204-5137, US

(21) Appl. No.: 10/024,069

(22) Filed: Dec. 18, 2001

Related U.S. Application Data
(60) Provisional application No. 60/257,440, filed on Dec. 22, 2000.

(51) Int. Cl. G06F 17/60

(52) U.S. Cl. 705/37

(57) ABSTRACT

The present invention provides a system and method for producing a crop with certified characteristics. In one preferred embodiment, the system includes negotiating a contract between a grower and a purchaser to provide a crop with specified characteristics. The contract information is then input into a secure database. The grower plants the crop using seeds which satisfy the specified characteristics and inputs crop statistic information into the database at various times during the crop's growing and harvesting cycle. At appropriate corresponding times during the planting, growing and harvesting process, an auditor inspects the grower's seed source, planting, cultivating, harvesting, machinery, transport and storage. The auditor creates an audit report by inputting certified audit results into the secure database. The audit report is then published to the buyer for comparison to the contract information. In alternate preferred embodiments, arranging the contract can take an auction format where a grower provides certified crop statistics, before or after the growing cycle, to a number of potential buyers who bid on the crop. Alternately, the contract can be in the form of a reverse auction where a potential buyer specifies desired characteristics and a number of growers have the chance to bid on providing a certified crop matching the requirements.

This application claims priority to provisional patent application Serial No. 60/257,440 filed on Dec. 22, 2000.

### FIELD OF THE INVENTION

This invention relates generally to producing crops, and more particularly to a system and method for producing crops which satisfy specified crop characteristics.

### BACKGROUND OF THE INVENTION

In the agricultural industry, many advances have been made by genetically manipulating crops in order to selectively improve desired characteristics. Additionally, there can be a marketing value for crops with guaranteed characteristics such as the ability to advertise that a crop is “organically” grown or that a crop is grown without certain specific chemicals. In other cases, it is desirable that the crop be certified as free from the introduction of contaminants in the planting, growing and harvesting process.

In certain instances, selective manipulation has led to mutations in the underlying crop genetics, which are hopefully preserved when the crop is reproduced. However, due to concerns over unexpected genetic manipulation, purity and contamination as well as to prevent undesired mutations, accurate records of a crop's growing cycle and treatment are needed. In particular, certain crop buyers and growers/producers enter into contracts regarding specified crop requirements such as the type and grade of crop to be grown and purchased, including the seeds used, the genetic uniformity, the purity, the chemicals used, the processing and the storage steps.

Once such a production contract has been arranged, it is in both the grower's and the buyer's best interest to ensure that the resulting crop satisfies the specifications in the contract. The present invention addresses this need.

### SUMMARY OF THE INVENTION

The present invention provides a system and method for producing a crop with certified characteristics. In one preferred embodiment, the system includes negotiating a contract between a grower and a purchaser to provide a crop with specified characteristics. The contract information is then input into a secure database. The grower plants the crop using seeds which satisfy the specified characteristics and inputs crop statistic information into the database at various times during the crop's growing and harvesting cycle. At appropriate corresponding times during the planting, growing and harvesting process, an auditor inspects the grower's seed source, planting, cultivating, machinery, transport and storage. The auditor creates an audit report by inputting certified audit results into the secure database. The audit report is then published to the buyer for comparison to the contract information.

In alternate preferred embodiments, arranging the contract can take an auction format where a grower provides certified crop statistics, before or after the growing cycle, to a number of potential buyers who bid on the crop. Alternately, the contract can be in the form of a reverse auction where a potential buyer specifies desired characteristics and a number of growers have the chance to bid on providing a certified crop matching the requirements.

In a preferred embodiment of the physical layout, the system uses an electronics package located adjacent the crop growing location. The electronics package includes a number of sensors and input devices for detecting crop statistics either automatically or manually at various times and transmits the collected crop statistics to a secure database using a connection such as a telephone line or internet connection or a wireless connection such as radio or cellular telephone. Also in a preferred embodiment, the auditor can input auditing information to the secure database using the electronics package and can communicate either by direct connection or wireless communication.

It is an object of the invention to provide an improved system and method for providing a crop which satisfies specified crop characteristics.

It is a further object of a preferred embodiment of the present invention to facilitate the arrangement of contracts, the provision of growing cycle information and/or the provision of audited results that the resulting crop satisfies specified characteristics.

Further objects, features and advantages of the present invention shall become apparent from the detailed drawings and descriptions provided herein.

### BRIEF DESCRIPTION OF THE DRAWINGS

FIGS. 1-5 are logical illustrations of steps of the system according to one preferred embodiment of the present invention.

FIG. 6 is a flow diagram illustrating the system according to a preferred embodiment of the present invention.

FIG. 7 is an overview of a physical layout of the system according to one preferred embodiment of the present invention.

FIG. 8 is an overview of a physical layout of the system according to an alternate preferred embodiment of the present invention.

FIG. 9 is an overview of a physical layout of the system according to another preferred embodiment of the present invention.

### DESCRIPTION OF PREFERRED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

In preferred embodiments, the present invention provides a system and method for crop buyers and growers to enter into specific contracts regarding the type and grade of a crop to be grown and purchased, including specific variables such as the genetic uniformity and purity, the chemicals used and the processing steps. To ensure accurate reporting and conformance of the crop to the specified crop characteristics, the system provides audited results to certify the crop statistics to the purchaser.

In preferred embodiments, a grower and a buyer negotiate to provide a crop with specific characteristics. Such a contract may require that specific information regarding the crop is recorded at various times during the growth cycle for identity preservation. Examples of these various times include before and during planting, before and during chemical applications, standardized intervals during the growing cycle and during harvesting and processing. The information is stored in a secure database, preferably run by a clearinghouse offsite from the growing location. The information may include the genetic integrity, genealogy and source of the seeds used as well as the field location, type of soil, tillage, nutrient levels, water, isolation barriers, the dates of planting, maturation and harvest, the predominate weather (temperature, wind, rain, humidity, barometric pressure), the prior and current history of the crop location and adjacent crops and similar variables. Information can also be collected regarding the cultivation process, including pesticides, herbicides or other chemicals used, and the condition of machinery and facilities used such as tractors, combines, planters, tillers, fertilizing machinery, watering equipment, harvesters and transport or storage containers. Preferably certain information is collected automatically, while other information is manually provided from the grower.

An audit provides verification and analysis of the collected crop statistical information such as the genetic genealogy of the crop, as well as inspection of any mechanical processes, equipment, facilities and chemicals used with or applied to the crop through the growth cycle and harvest. The audit inspection is conducted at various times by one or more auditors during the planting, growing and harvesting processes to certify the corresponding information supplied by the grower. As needed, the grower may subcontract portions of the inspection, for example by sending seeds or product to testing laboratories. Each laboratory is then also inspected by the auditor. Preferably, the auditor provides the audit results in a report entered into the secure database. In one preferred embodiment, the auditor(s) is provided by an independent third party such as the clearinghouse, while in alternate embodiments the auditor(s) is supplied directly by the grower or buyer.

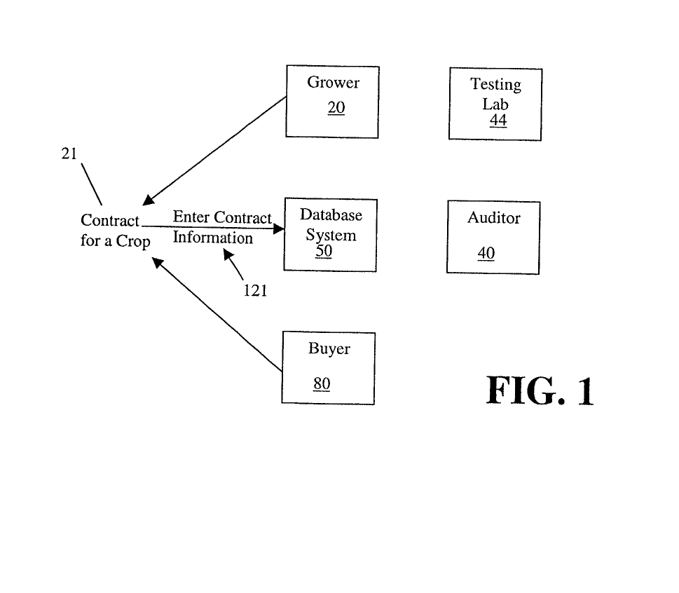

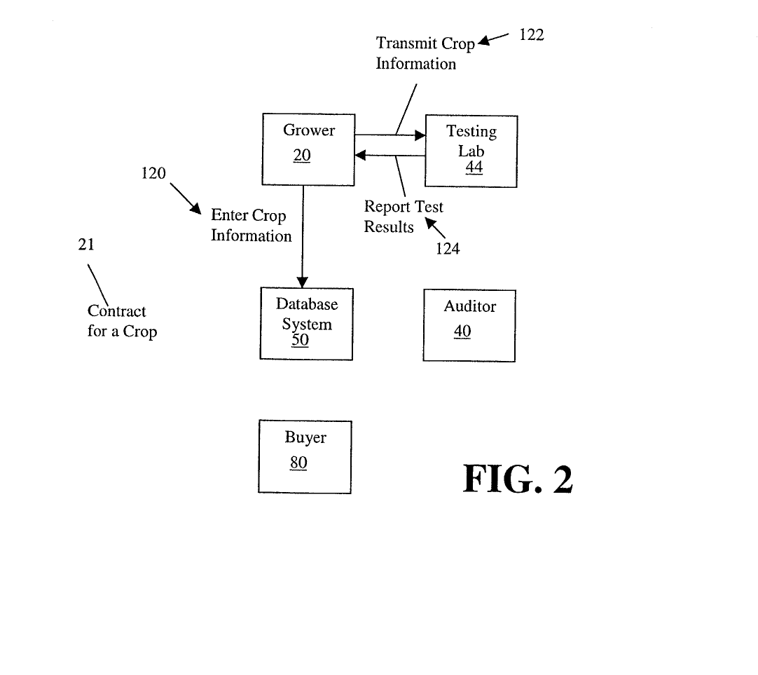

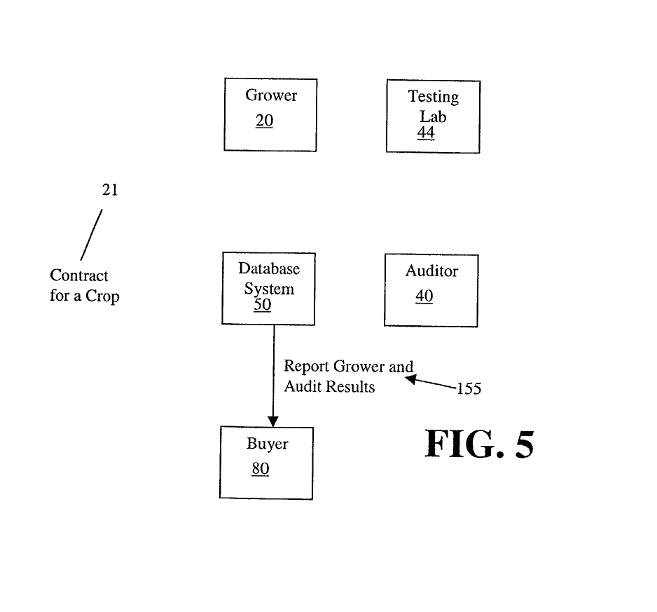

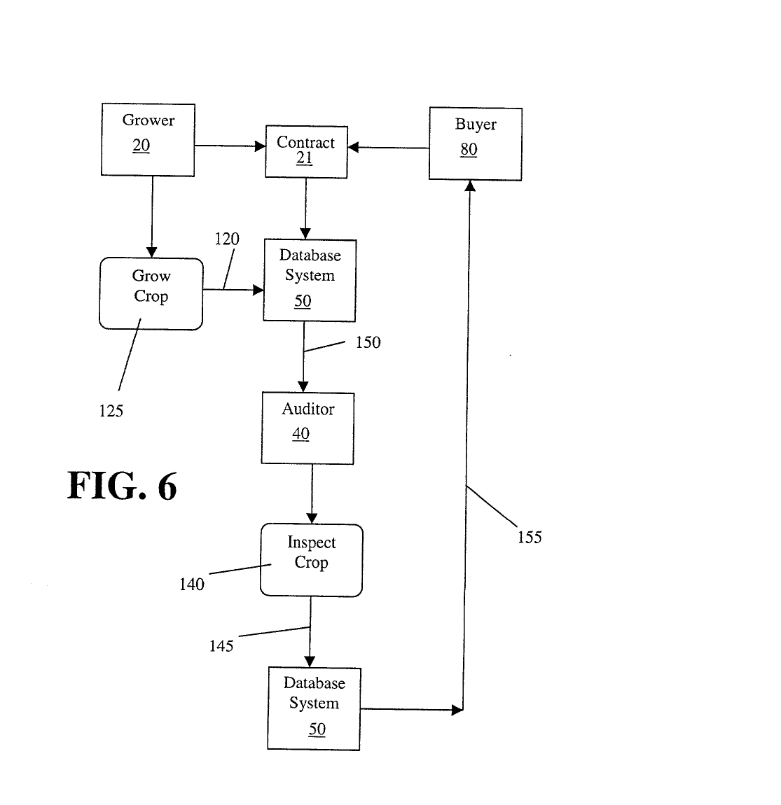

In one embodiment of the present invention, illustrated in logical steps in FIGS. 1-5 and illustrated in a flow diagram in FIG. 6, a grower/producer 20 and a buyer 80 agree to a contract 21 for a specific crop. In step 121 the contract specifications are then entered into a central clearinghouse or database system 50. Next, the grower 20 proceeds to grow the crop 125 and reports the crop information or statistics (FIG. 2, step 120) at various times to the database system 50. The grower 20 may subcontract to send certain crop information for testing (step 122), such as seeds or sample products for genetic testing, to a laboratory 44 as needed to obtain specific test results (step 124).

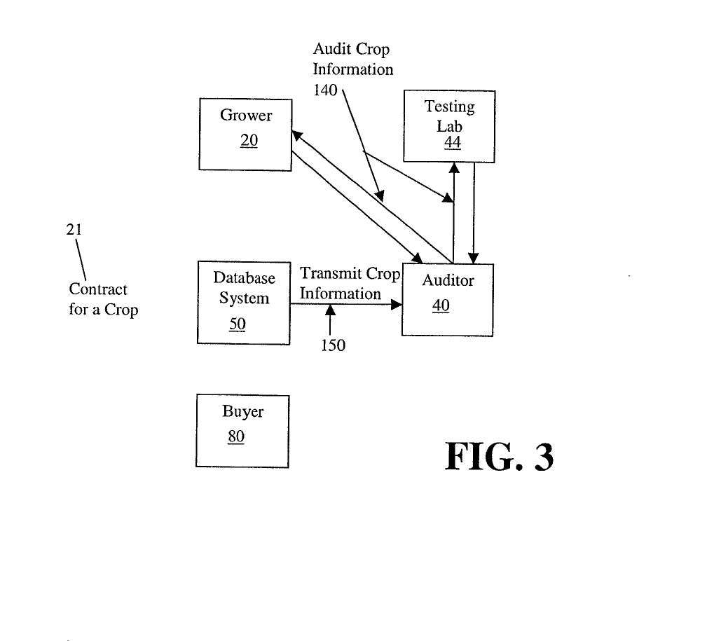

After the grower 20 has entered the crop information, an auditor 40 receives the crop information from the database system (FIG. 3, step 150) and independently examines (step 140) the producer's systems, equipment and facilities from which the information was obtained. The inspection(s) may occur before, during and/or after the crop growing cycle as appropriate for inspecting and verifying corresponding information. If the grower has had testing subcontracted, as part of step 140 the auditor 40 inspects the laboratory's 44 equipment, standards and procedures as well.

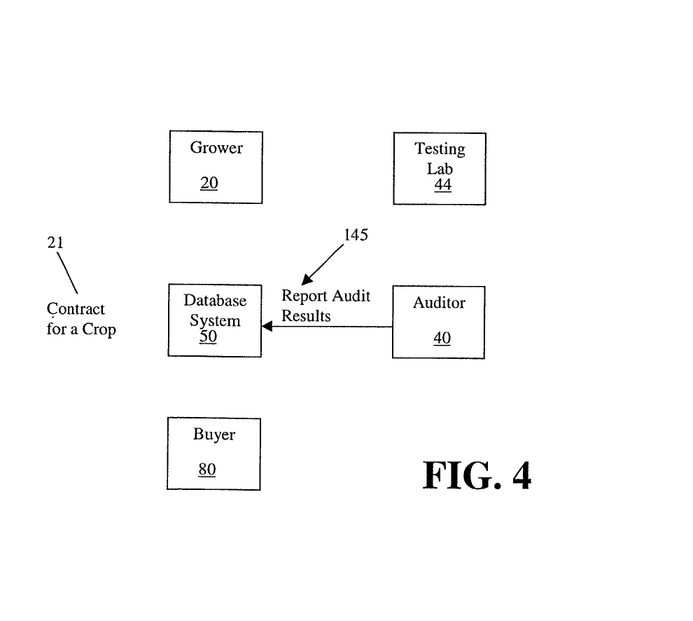

Upon completion of the auditing process, the auditor reports the audit results (step 145) to the database system 50, (FIG. 4). In a preferred embodiment, the auditor reports the testing information directly to the database system, for example with a personal data terminal or scanner such as a Palm Pilot® which can be downloaded or synchronized to report results over a computer network to database system 50. In a less preferred embodiment, the auditor can report the results on paper to the clearinghouse which then loads the audit information into the database.

Upon receipt of the crop information and audit results into the database system 50, all the information is published to the buyer, (step 155). The buyer can access the database system, preferably in real-time over a computer network, and review the information from the producer as well as the audited results. Preferably the buyer has access to up-to-date information and can access the database at any time during the growing process. Various types of reports and formats can be generated as desired. Reports can be generated at various points in the crop cycle for chronological tracking and/or analysis. The buyer can then rely on the audited information in response to questions or in certifying the specifications of the crop. The certification can be done for the raw crop alone or for a crop used as an ingredient or portion contributing to the labeling for an eventual processed product. After the crop statistics have been certified as satisfying the crop characteristics of the contract, transport arrangements 90 are made to send the crop to the desired location such as a market or processing plant 100. Preferably accompanying paperwork, such as invoices or labeling with identifying information, for example a bar code, batch number or serial number, remains with the product for tracking purposes.

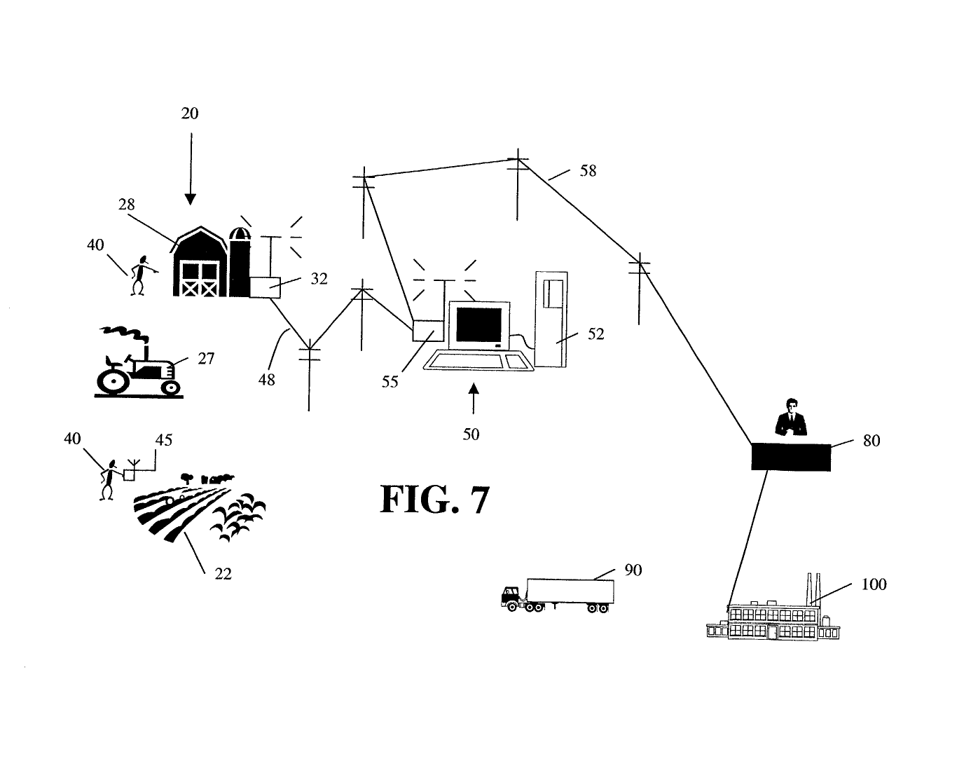

In a physical layout of the system, illustrated in FIG. 7, grower 20 is a farmer or similar commodity producer typically having a field 22, machines 27 and a barn/storage facility/office 28. The grower 20 has an electronics package 32 accessible adjacent the growing location typically in the barn/office 28 or adjacent field 22. The grower can report information using the electronics package 32; for example using an office computer. Electronics package 32 communicates using a direct connection 48 such as a cable, telephone line or internet connection, or may use wireless reporting such as by radio communications or a cellular phone network to secure database system 50.

In an alternate embodiment, the electronics package 32 can record objective information automatically such as time, date, weather, temperature, barometric pressure, and wind speed using a number of sensors. In a further alternate embodiment, the information can be initially recorded by the grower in a portable electronic device and then downloaded or synchronized with a computer, or the device may use a wireless communication ability capable of reporting from anywhere in the general vicinity.

Secure database system 50 includes a receiver/transmitter 55 which is used to send and receive data using various communication methods such as a modem, internet, wireless or cable connection. Database system 50 also includes a storage/processing unit 52. Database system 50 is preferably physically separated from grower 20, and may be independently owned and managed.

An auditor or auditors 40 receive crop information from database system 50 and physically inspect the grower's facility including any fields 22, machines 27 and barn/storage facilities 28. The audit may be conducted by one or more individuals who record their results to form an audit report. Preferably the auditor uses a portable computer or personal digital assistant type of device 45 during the inspection. The device 45 can then be downloaded or synchronized to report its results to database system 50. The auditor may download device 45 on-location using the grower's electronics package 32, or may return to the auditor's office and send the results. Preferably the auditor is a qualified individual or individuals who have experience and training to conduct quality inspections and are certified by a licensing association or a state or federal agency.

After receiving the audit report, database system 50 publishes or reports the results to buyer 80, preferably in real time using a communications connection 58 such as a global computer network. As a preferred feature, buyer 80 has access to the information from the grower 20 and the auditor 40 as soon as the information is reported to secure database 50. Buyer 80 can compare the audit report results to contracted crop characteristics, and arranges for transportation 90 of the crop from grower 20 to processor 100.

In a preferred embodiment of the present invention, the database system is connected to a global computer network and is created, maintained and supported through an independent clearinghouse. The clearinghouse supports the equipment for the database system and coordinates the communications access and information flow between the producer, buyer, auditor and testing lab. The clearinghouse can also hire, train, certify and pay the auditor and testing costs as part of its service.

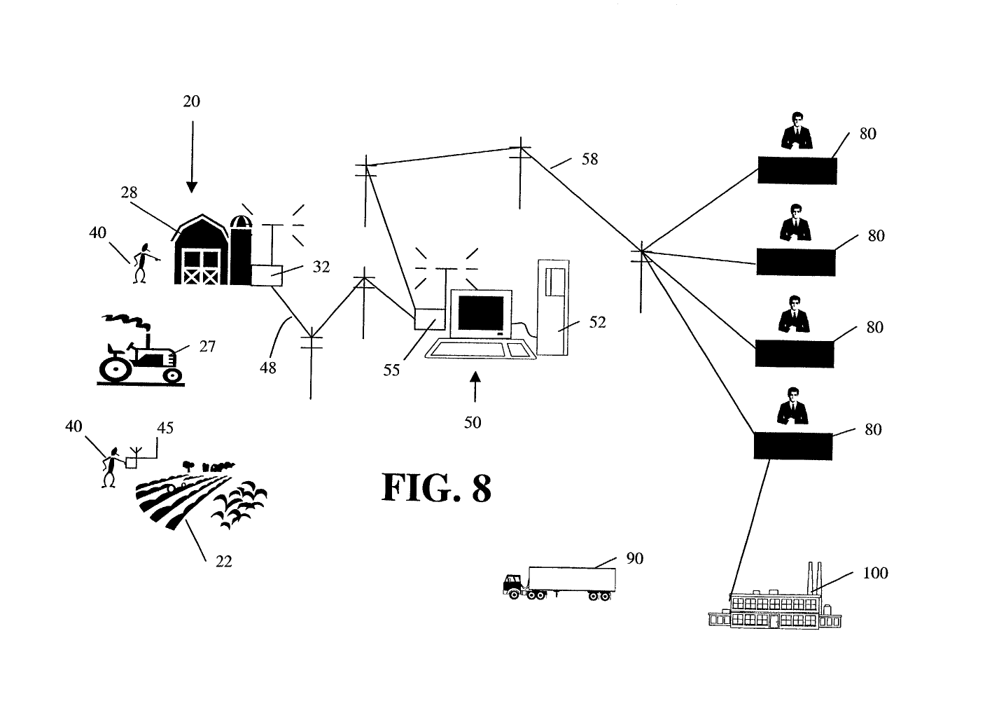

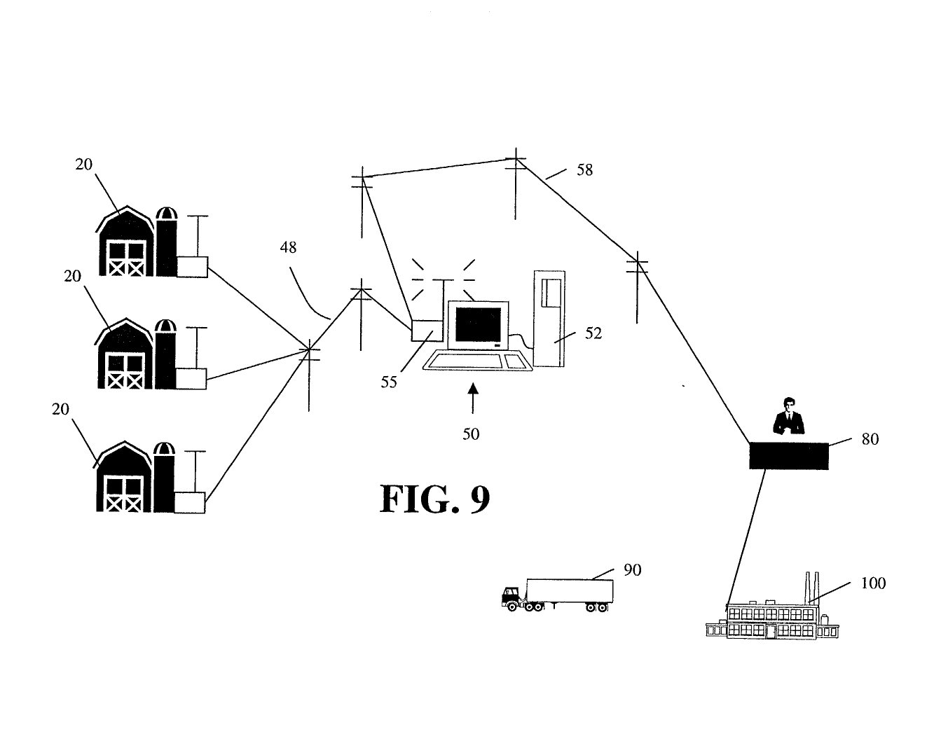

In an alternate preferred embodiment, illustrated in FIG. 8, the database system 50 can serve as a clearinghouse or auction and a certification system for a grower/producer 20 who wishes to make a crop available on the open market or for an auction to a number of buyers 80 who may bid on the price for a present or future harvested crop. In another embodiment, illustrated in FIG. 9, a buyer 80 may provide contract specifications for a reverse auction where a number of growers 20 bid for the contract to supply a present or future crop. In these preferred embodiments, the database system may include auction features where multiple buyers may bid on the highest price for one grower's offered crop before, during or after the growing cycle, or, conversely, multiple producers may bid on the lowest cost to obtain a buyer's offered contract.

In one preferred embodiment, the auditor and testing lab are independent, objective third parties commissioned by the management of the database system. In an alternate embodiment, the auditor and testing lab could be directly commissioned and paid directly by the grower and/or buyer with the results information being maintained in the database. The clearinghouse database service preferably sells subscriptions to growers and sellers with a price structure based on the management involvement of the clearinghouse and whether the transaction is a one-to-one contract or an auction arrangement. The business arrangements and level of service or access requested will effect the subscription price charged by the database system to the producer and/or the buyer.

To maintain information validity and control, each party agrees to a subscription where the party only has limited access to enter, read and/or edit the data recorded in the secure database system. This prevents fraud as well as maintaining a clear record of the history for a particular crop being tracked. For example, the grower will have write access to input crop statistics. The auditor will have read-only access to the information from the grower and will have write privileges for reporting the audit results. The buyer(s) will have read-only access to the crop statistics and audit reports. Subscriptions to reports from the database system can be selectively billed according to the variables, format and information requested and/or reported. Details of most contracts will be maintained as confidential to the parties, with the exception of auction type transactions which will be open to multiple system subscribers. In a further preferred feature, eventual consumers may have read-only access to the database, based on batch or lot numbers, to verify the processor's claims for the crop or ingredients, such as claims that a product was “organically grown.”

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for producing a crop with certified characteristics, comprising the steps of:
a) negotiating a contract between a grower and a buyer to provide a crop with specified characteristics;
b) inputting the specified characteristics into a secure database;
c) planting a crop with seeds which satisfy said specified characteristics;
d) inputting crop statistics during the growing cycle of the crop to said secure database;
e) auditing said crop statistics by an auditor to certify that said crop statistics are accurate;
f) entering an auditing report into said secure database to compare said auditing report to said specified characteristics; and,
g) publishing said crop statistics and said auditing report from said secure database to said buyer.

2. The system of claim 1 where said secure database is hosted by a third party.

3. The system of claim 2 where said auditor is an independent auditor.

4. The system of claim 3 wherein said grower sub-contracts a testing laboratory to test certain crop characteristics.

5. The system of claim 3 wherein said independent auditor has read-only privileges to said crop statistics information.

6. The system of claim 3 wherein said independent auditor is paid by said third party.

7. The system of claim 3 wherein said independent auditor is paid by said buyer.

8. The system of claim 2 wherein said buyer has read-only privileges to said crop statistics information and said auditing report information.

9. The system of claim 8 wherein said buyer has real time access to said crop statistics in said secure database during the crop growing cycle.

10. The system of claim 1 further comprising installing an electronics package at the growing location of said crop.

11. The system of claim 10 wherein said auditor inputs audit results to said electronics package.

12. The system of claim 1 wherein said crop statistics includes genetic information about the seeds used and genetic information about the final crop product.

13. The system of claim 12 wherein said crop statistics includes information about the crop selected from the following: chemicals used on the crop, weather information at specified times during the growing cycle, information about previous crops planted in the same crop location, and adjacent land use information.

14. The system of claim 13 wherein said crop statistics includes inspection records for the containers and machines used with the crop.

15. A system for selling a crop with certified characteristics, comprising the steps of:
a) choosing to provide a crop from a grower with specified characteristics;
b) inputting the specified characteristics into a secure database;
c) inputting crop statistics during the growing cycle of the crop to said secure database;
d) auditing said crop statistics by an auditor to certify that said crop statistics satisfy said specified crop characteristics; and,
e) publishing said certified crop statistics from said secure database for auction to one or more potential buyers.

16. The system of claim 15 where said secure database is hosted by a third party.

17. The system of claim 16 where said auditor is an independent auditor.

18. The system of claim 17 wherein said independent auditor is paid by said third party.

19. The system of claim 18 wherein said independent auditor is paid by said buyer.

20. The system of claim 15 further comprising installing an electronics package at the growing location of said crop.

21. The system of claim 20 wherein said auditor inputs audit results to said electronics package.

22. A system for buying a crop with certified characteristics, comprising the steps of:
a) inputting a buyer's specified characteristics for a desired crop into a secure database;
b) publishing said specified characteristics from said secure database to a number of potential growers;
c) using said secure database to arrange a contract between the buyer and a grower to grow a crop satisfying said specified characteristics;
d) planting a crop which satisfies said specified characteristics;
e) inputting crop statistics during the growing cycle of the crop to said secure database;
f) auditing said crop statistics to certify that said crop statistics are accurate;
g) entering an auditing report into said secure database for comparison of said auditing report to said specified characteristics; and,
h) publishing said crop statistics and said auditing report from said secure database to said buyer.
